(19) United States
(12) Patent Application Publication
(10) Pub. No.: US 2026/0014566 A1
(43) Pub. Date: Jan. 15, 2026

(54) CONCAVE RETAINING AND REMOVAL SYSTEM FOR CRUSHERS

(71) Applicant: Metso USA Inc., Brookfield, WI (US)

(72) Inventors: Timo Bischof, Münster (DE); Julian Weßeling, Münster (DE)

(73) Assignee: Metso USA Inc., Brookfield, WI (US)

(21) Appl. No.: 18/769,894

(22) Filed: Jul. 11, 2024

(51) Int. Cl. B02C 2/04; B02C 2/00

(52) U.S. Cl. CPC B02C 2/04; B02C 2/005; B02C 2210/01

(57) ABSTRACT

A removable and replaceable crushing shell for use in a top shell of a gyratory or cone crusher. The crushing shell includes a series of concaves that are arranged in a row with straight side walls of the concaves in contact with each other. A wedge concave is positioned within a receiving gap between two adjacent concaves. The wedge concave includes opposite angled side walls that converge in a radially outward direction. One or more connectors hold the wedge concave in place on the frame of the top shell. A wedge is inserted between the angled side walls of the wedge concave and the straight side walls of the concaves to restrict radially outward movement of the wedge concave. The wedge concave can be removed from the crushing shell though a inward force to release hoop stresses in the row of concaves.

### BACKGROUND

The present disclosure generally relates to a replaceable crushing shell including a series of concaves for use in a top shell of a gyratory or cone crusher. More specifically, the present disclosure relates to a concave retaining system that allows for the removal of concave segments without the need for heat destruction.

Gyratory crushers and cone crushers are two types of rock crushing systems which generally break apart rock, stone or other material in a crushing gap between a stationary element and a moving element. A gyratory or cone crusher is comprised of a head assembly including a crusher head that gyrates about a vertical axis within a stationary bowl attached to a main frame of the rock crusher. The crusher head is assembled surrounding an eccentric that rotates about a shaft to impart the gyratory motion to the crusher head which crushes rock, stone or other material as the material travels through a crushing gap between the crusher head and the bowl. The crushed material exits the crusher through the bottom of the crushing gap.

The eccentric can be driven by a variety of power drives, such as an attached gear, driven by a pinion and countershaft assembly, and a number of mechanical power sources, such as electrical motors or combustion engines.

While gyratory crushers and cone crushers operate according to the same principles, the longer shaft or spindle of a gyratory crusher regularly has its upper end supported by a spider bearing, whereas the shorter spindle of the cone crusher is not suspended but supported in a bearing below the gyratory head or cone. Gyratory crushers are often used as primary crushers, i.e. heavy-duty machines designed to process large material sizes. Secondary and tertiary crushers are intended to process relatively smaller feed materials. Cone crushers are often utilized as downstream crushers.

Gyratory and cone crushers utilize wear parts to protect the machine from damage and perform the actual crushing of the material. The two types of wear part are the mantle and a crushing shell formed from a set of adjacent liner segments, often concave liner segments. The mantle is fixed to the main shaft, and the concave liner segments (or simply “concaves”) are fixed to the frame of the top shell of the crusher. The concaves are arranged in several rows sitting on top of each other.

Wear parts may be made from chilled cast iron or from steel alloy, such as manganese steel, depending on the character of the material to be crushed and the particular class of service for which the machine is intended. Manganese steel combines extreme toughness with high wear resistance and has therefore developed into the universal choice for crushing hard, tough rock, even regardless of the class of service or the type of crusher. A common material is 12-14% manganese steel, also known as Hadfield steel. Different alloys have been used for liner segments in upper, middle and bottom parts of the crushing chamber.

Typically, both the mantle and the concaves wear and distort due to the significant pressures and impact loading forces they transmit. It is common to use backing compounds, e.g. an epoxy backing, to structurally reinforce the concaves and assist with contact between the radially outward facing surface of the concaves and the radially inward facing surface of the top shell or frame. In fact, the crushing forces must be transferred to the concaves from the structural crusher parts which they protect, and for that, intimate contact is needed between the back of the concaves and the surface of the top shell or frame.

The aforementioned wear parts are changed regularly, i.e. in intervals of 12, 18 or 24 months. The replacement is a relatively fast process for the mantle, which is usually replaced by swapping for a spare main shaft assembly. In contrast, the replacement of the concave liners is cumbersome. Typically, one unit per row—the so-called keystone’ or ‘key segment’—is removed first so as to release any hoop stresses stored in the respective row of concaves. This is commonly done by using a thermal lance to cut a valley in the concave which therefore allows it to be chiseled off with a rock breaker or other such hammer system. Once the ‘keystone’ concave is removed, the remaining concaves in the row are removed one by one along the circumferential direction—a rock breaker, i.e. a hydraulic or pneumatic hammer, is driven behind the concaves at the top leading edge to break the epoxy backing between the concaves and the supporting frame of the crusher and to remove the concaves one by one.

In a large primary gyratory crusher, there are several rows of concaves to replace, such as e.g. four tiers (rows) with 20 segments per tier. The existing methodology for the removal and replacement of concave liners—a process also known as a “re-metal”—is very time consuming, often taking multiple days to complete. This equals downtime and lost production for the operator of the mine. As explained above, gyratory crushers are frequently used for first stage sizing in the minerals processing industry, so that any associated downtime can have serious consequences for downstream processing and therefore the overall plant productivity.

The removal of concaves requires the use of hot works, such as a torch or heat lance, as well as the operation of a large rock breaker. Also, workers have to be specially trained to be able to operate inside the top shell area of the crusher. The use of the hot works and the location of the worker within the crusher places the worker at risk and it is desirable to create a system and method that does not require hot works.

### SUMMARY

The present disclosure relates to a replaceable crushing shell including a series of concaves for use in a top shell of a gyratory or cone crusher. More specifically, the present disclosure relates to a concave retaining system that allows for the removal of concave segments without the need for heat destruction

According to one exemplary embodiment of the present disclosure, a top shell for a gyratory or cone crusher is provided that includes a frame having a circular top end and a circular bottom end that are joined to each other by an inner wall that defines a crushing chamber for the crusher. The inner wall decreases in internal diameter from the top end to the bottom end of the frame to direct material to be crushed into the decreasing size crushing chamber.

A plurality of concaves are arranged in at least one row along the inner wall of the frame. Each of the concaves is positioned adjacent to another concave to define the row of concaves. The concaves each include a wear surface that faces the crushing chamber when the concave is installed. The wear surface contacts the material being crushed during operation and is thus subject to wear during operation of the crusher. The concaves further include a back surface that is placed in contact with the inner wall of the frame and is attached to the inner wall of the frame.

The width of the wear surface of the concave is essentially the same as the width of the back surface such that the wear surface and the back surface are joined by a pair of straight side walls at the spaced first and second sides of the concave. When the concaves are positioned adjacent to each other, the straight side walls contact each other along the entire height of the concave.

When the row of concaves is created, a receiving gap is created between two of the concaves. The receiving gap has the same size as the width of the concaves to provide an opening to receive a specially designed and unique wedge concave. The wedge concave of the present disclosure is constructed separately from the other concaves and has a different configuration to allow the wedge concave to be more easily removed from the row of concaves to enhances the removal and replacement of the entire crushing shell formed from the concaves.

The wedge concave of the present disclosure includes a wear surface that faces the crushing chamber and a back surface that is in contact with the inner wall of the frame. Unlike the other concaves, the length of the wear surface of the wedge concave is greater than the width of the back surface such that the wear surface and the back surface are joined to each other by a pair of angled side walls at the first and second sides of the wedge concave. The angled side walls of the wedge concave thus converge in the radially outward direction of the top shell. When the wedge concave is positioned within the receiving gap between the spaced concaves, a pair of access gaps are created between the straight side wall of the concave and the angled side walls of the wedge concave. The size of the access gaps increases in the radially outward direction.

The crushing shell further includes a pair of wedges that are each positioned in one of the access gaps between the wedge concave and the concaves in contact with the wedge concave. In the exemplary embodiment of the present disclosure, the wedges each include a body having a straight side wall and an angled side wall. The straight side wall of the wedge contacts the straight side wall of the concaves and the angled side wall contacts the angled side wall of the wedge concave.

In one contemplated embodiment, at least one connector, such as a bolt, is used to secure the wedge concave to the frame of the top shell. The connector extends through a connector opening formed in the frame and is received in the back surface of the wedge concave. The interaction between the connector and the wedge concave holds the wedge concave in place on the frame. When the wedge concave is to be removed, the connector can be removed from the exterior of the frame of the top shell.

In accordance with one embodiment of the present disclosure, the crushing shell can be provided as a retrofit for existing gyratory or cone crushers. The crushing shell includes the plurality of concaves, the wedge concave and the pair of wedges. The use of the crushing shell of the present disclosure allows the crushing shell to be removed without the need for a thermal lance or other heat element.

The present disclosure also provides a method for installing a crushing shell on an inner wall of a frame of a top shell of a gyratory or cone crusher. Initially, a plurality of concaves are installed in at least one row along the inner wall of the top shell with a back surface of each concave in contact with the inner wall and a wear surface of the concave facing a crushing chamber of the crusher. Each of the concaves includes a straight side wall on each of the first and second ends such that the straight side walls of adjacent concaves contact each other.

During the creation of the row of concaves, a receiving gap is created between two of the concaves. The receiving gap is sized to receive a specially designed wedge concave that is unique from the other concaves. The wedge concave is installed in the receiving gap such that angled side walls on the first and second sides of the wedge concave contacts the straight side walls of the two space concaves that define the receiving gap.

Once the wedge concave is installed, a pair of wedges are inserted between the wedge concave and one of the two concaves that form the receiving gap. The wedges contact the wedge concave and the two concaves to create a holding force in a hoop direction of the frame of the top shell. The wedge concave can be attached to the frame by one or more connectors that extend through connector openings formed in the frame. The connectors are each received in the back surface of the wedge concave.

When the concaves of the crushing shell become worn, the wedge concave can be removed without the need for a torch lance as a result of the angled side walls formed on the wedge concave. Initially, the one or more connectors are removed to disconnect the wedge concave from the frame. With the connectors removed, a removal tool is used to push the wedge concave away from the frame. In one contemplated embodiment, the removal tool is a release cylinder that is attached to the outer surface of the frame. The release cylinder extends through the frame and exerts a radially inward pushing force to push the back surface of the wedge concave away from the frame.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of a crusher of one exemplary embodiment of the present disclosure;

FIG. 2 is a section view of the crusher of the exemplary embodiment of FIG. 1;

FIG. 3 is a top perspective view of a top shell with an installed row of concaves;

FIG. 4 is a top perspective view of the crushing shell including a row of concaves, a wedge concave and wedges in accordance with the present disclosure;

FIG. 5 is a magnified view taken along line 5-5 of FIG. 4;

FIG. 6 is a top view of the row of concaves shown in FIG. 4;

FIG. 7 is a magnified view taken along line 7-7 of FIG. 6;

FIG. 8 is a rear perspective view of two concaves, the wedge concave and the two wedges; and

FIG. 9 is a partial section view showing the installation of a release cylinder on the frame to remove the wedge concave.

### DETAILED DESCRIPTION

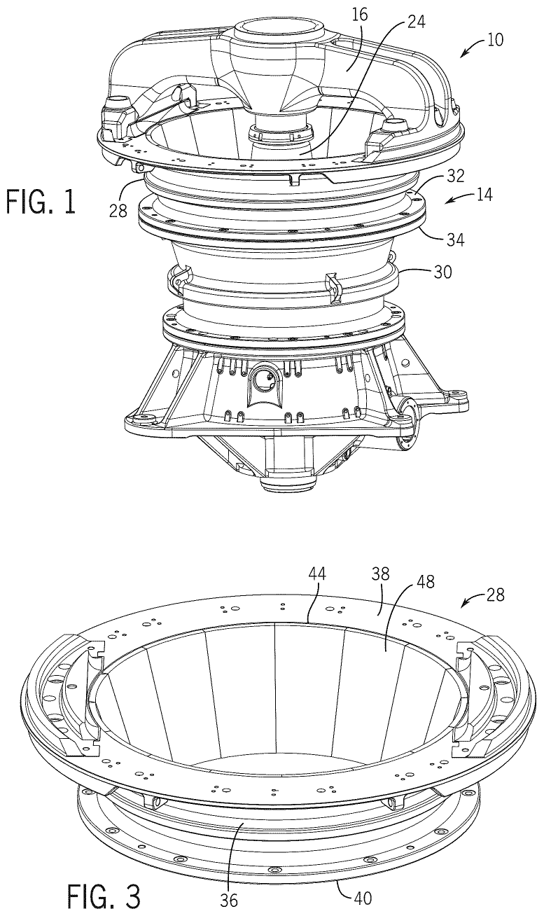

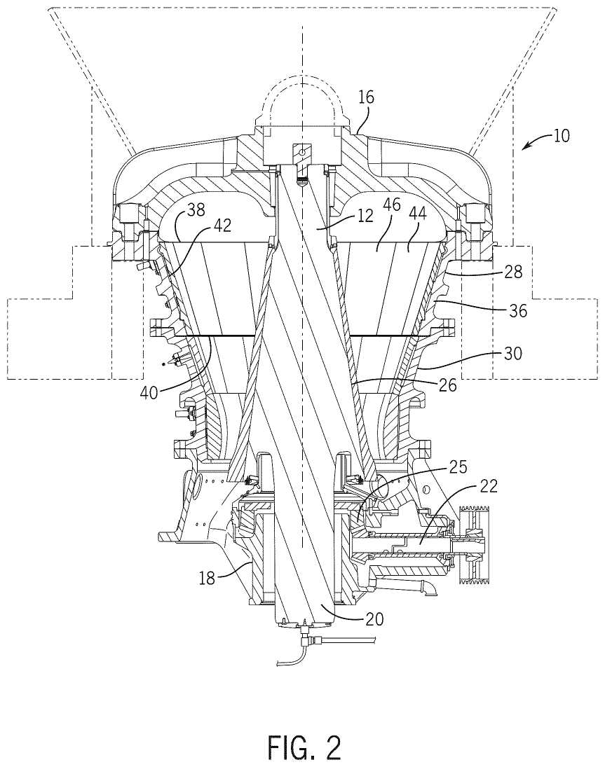

FIGS. 1 and 2 illustrate a gyratory crusher 10 that incorporates a crushing shell and the concave retaining and removal system of the present disclosure. The views of FIGS. 1 and 2 are included to provide a general illustration of the basic operating principles of a gyratory cone crusher and are not to be understood to imply any limitation of the present disclosure. The gyratory crusher 10 includes a vertically extending main shaft 12 that extends through a main frame 14. The main shaft 12 has a longitudinal axis that coincides with a central axis of the main frame 14. The main shaft 12 is suspended within a spider 16. The crusher includes an eccentric assembly that rotatably supports the bottom portion 20 of the main shaft 12. The eccentric assembly is driven by a drive shaft 22 that imparts rotating and oscillating movement to the main shaft 12 through a gear assembly 25.

The main shaft 12 includes a mantle 24 that is mounted to the crusher head 26. The mantle 24 is designed as a removable wear component that can be removed from the head 26 of the main shaft 12 upon wear. Referring now to FIG. 1, the main frame 14 includes a top shell 28 and a lower top shell 30 that are mounted on top of each other and joined by an overlapping pair of flanges, designated as the upper flange 32 and the lower flange 34. In this manner, the entire main frame 14 can be formed from a separate top shell 28 and a lower top shell 30 that can be assembled onsite, which increases the ability to ship the gyratory crusher for assembly onsite.

As shown in FIG. 2, the upper top shell 28 includes a frame 36. The frame 36 extends from a top end 38 to a bottom end 40. The frame 36 includes an inner wall 42 that decreases in diameter from the top end 38 to the bottom end 40 to direct material downward and inward within the frame 36. The bottom top shell 30 also includes a top end 41 and a bottom end 43 that are joined by an inner wall 45 that also decreased in diameter from the top end 41 to the bottom end 43. The decreasing diameter of the inner wall 45 directs the material downward and inward to decrease the size of the crushing gap to reduce the size of the material being crusher.

In the embodiment shown, the frame 36 supports an outer crushing shell 44, also commonly referred to as a bowl, that is mounted to the inner wall 42 of the frame 36. A crushing gap 46 is formed between the outer crushing shell 44 and the mantle supported on the head 26 of the main shaft 12. The size of the crushing gap decreased in a downward vertical direction. When the crusher 10 is operated, material to be crushed is introduced into the crushing gap 46 and is crushed between the mantle and the outer crushing shell 44 as a result of the gyrating movement of the crusher head during which the mantle approaches the outer crushing shell 44 along a rotating generatrix and moves away from the crushing shell along a diametrically opposed generatrix.

As shown in the embodiment of FIG. 2, the bottom top shell 30 can also include an outer crushing shell to protect the inner wall 45 from wear during operation of the gyratory crusher. The outer crushing shell is similar to the outer crushing shell 44 and is supported along the inner wall 45. Throughout the remainder of the disclosure below, it should be understood that an outer crushing shell could be installed in the upper top shell 28, the bottom top shell 40 or both the upper and bottom top shells. The term “top shell” will refer to either of the two top shells that combine to form the main frame 14.

As can be seen in FIGS. 2 and 3, the outer crushing shell 44 included in the upper top shell 28 is formed from a series of individual liner segments that face toward the center of the outer crushing shell. The liner segments shown in FIGS. 2 and 3 are arranged in at least one tier or row along the frustoconical inner wall 42. In the present disclosure, the replaceable liner segments are provided in the form of concave liners, also designated concaves in view of their concave shape which follows the concave shape of the inner wall of the frame 36. The expression “concaves”, “liners” and “wear segments” may therefore be used interchangeably to designate the liner segments. In the present disclosure, the term concave will be used to refer to each of the liner segments, as illustrated by reference numeral 48.

During the operational state of the crusher, an epoxy backing (not specifically illustrated), is poured into the gap between the outer surface of the concaves 48 and the facing inner circumferential surface defined by the inner wall 42. The epoxy backing is, in a manner known, provided to structurally reinforce the concaves 48 and assist with the contact between the radially outward facing surfaces of the concaves 48 and the radially inward facing surface of the inner wall 42. The epoxy backing material fills the void between the concaves 48 and the inner wall 42 to provide a solid assembly. The use of the epoxy between the concaves 48 and the inner wall 42 increases the difficulty in removing the concaves 48 upon wear.

As can be seen in FIG. 3, the concaves 48 are arranged adjacent to each other in a tier or row along the inner circumference of the frame 36 of the upper top shell 28. During use of the gyratory crusher 10, when the concaves 48 become worn and need to be replaced, one of the concaves 48 must be removed to release any hoop stresses stored in the respective row of concaves 48. Conventional crushers typically require the gouging out of one of the concaves 48 in order to allow the remaining concaves 48 to be removed. Typically, one of the concaves is removed by thermal lancing, which can be a difficult and dangerous task for a worker. In accordance with the present disclosure, one of the concaves in the row of concaves is specifically designed such that it can be more easily removed without the need for thermal lancing to release the hoop stresses on the remaining concaves 48 to allow easier removal of these remaining concaves 48.

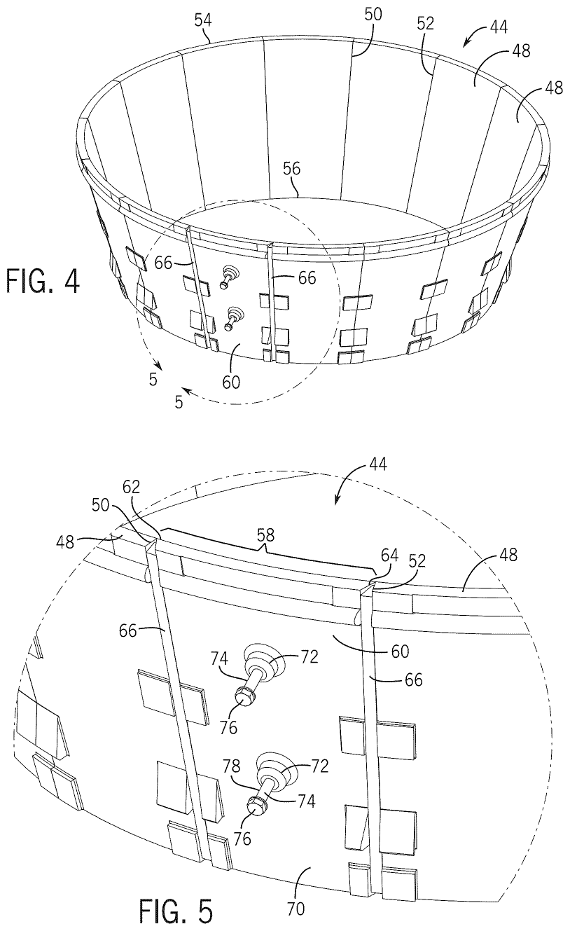

FIG. 4 illustrates the outer crushing shell 44 constructed in accordance with the present disclosure. As previously discussed, the outer crushing shell 44 is installed within the upper top shell and held in contact with the inner wall of the frame of the upper top shell by an epoxy backing layer. In the embodiment shown in FIG. 4, the outer crushing shell 44 is shown removed from the upper top shell 28 and is shown in isolation for the ease of understanding.

The outer crushing shell 44 is formed from a plurality of concaves 48 that are positioned adjacent to each other to define a single row of concaves 48. Each of the concaves 48 has an identical configuration and has a circumferential width extending between a first side 50 and a second side 52. Each of the concaves 48 has a height that is defined by the top end 54 and the bottom end 56. Although the crushing shell 44 is shown with only a single row of concaves 48, it should be understood that depending on the size of the crusher, multiple rows of concaves 48 could be used to form the crushing shell 44.

As shown in FIGS. 4 and 5, a receiving gap 58 is created between a first side 50 of the first (left) concave 48 and the second side 52 of a second (right) concave 48. The receiving gap 58 has the same dimension as the width of one of the concaves 48 between the first and second sides 50, 52. In accordance with the present disclosure, a specially designed wedge concave 60 is inserted into the receiving gap 58 in place of one of the typical types of concaves 48. The wedge concave 60 has a width that is defined between a first side 62 and a second side 64.

The outer crushing shell 44 of the present disclosure further includes a pair of wedges 66 that are installed between the wedge concave 60 and the pair of concaves 48 that are spaced from each other to define the receiving gap 58. The wedges 66 are inserted between the wedge concave 60 and the pair of spaced concaves 48 to create a holding force in the hoop direction between the plurality of the installed concaves 48.

As can best be understood in FIGS. 5 and 7, the wedge concave 60 includes an inwardly facing wear surface 68 and an outwardly facing back surface 70 that define the thickness of the wedge concave 60. The back surface 70 includes a pair of receiving bosses 72 that protrude from the back surface 70. Each of the receiving bosses 72 includes an internally threaded opening sized to receive a connector, such as but not limited to a connecting bolt 74. Although a connecting bolt 74 is shown in the exemplary embodiment, the connector could be a threaded stud, stud screw with a nut, a bolt with a chamfer disc or a bolt with a wedge as long as the connector functions to pull the wedge concave 60 back. In the illustrated embodiment, the connecting bolts 74 each include a head 76 and a threaded shaft 78.

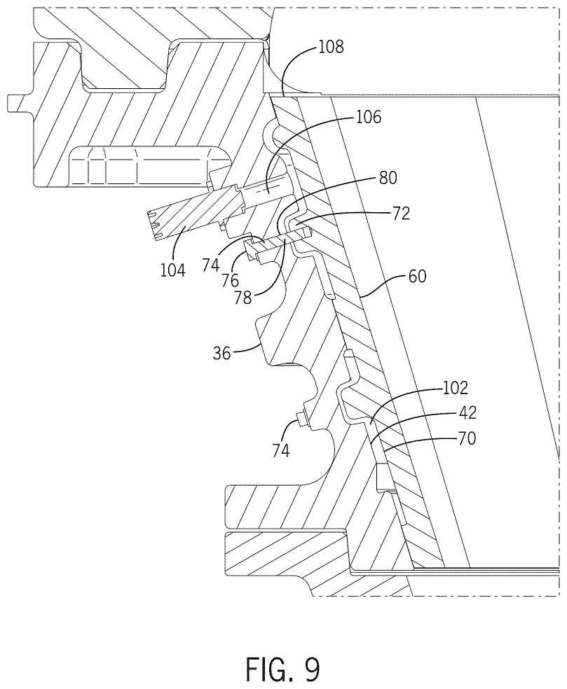

When the wedge concave 60 is installed on the frame 36, as shown in FIG. 9, the connecting bolt 74 extends through a connector opening 80 formed in the frame 36 such that the threaded shaft 78 is received within the internally threaded receiving boss 72. In this manner, the pair of connecting bolts 74 aid to hold the wedge concave 60 in place along the inner wall 42 of the frame 36.

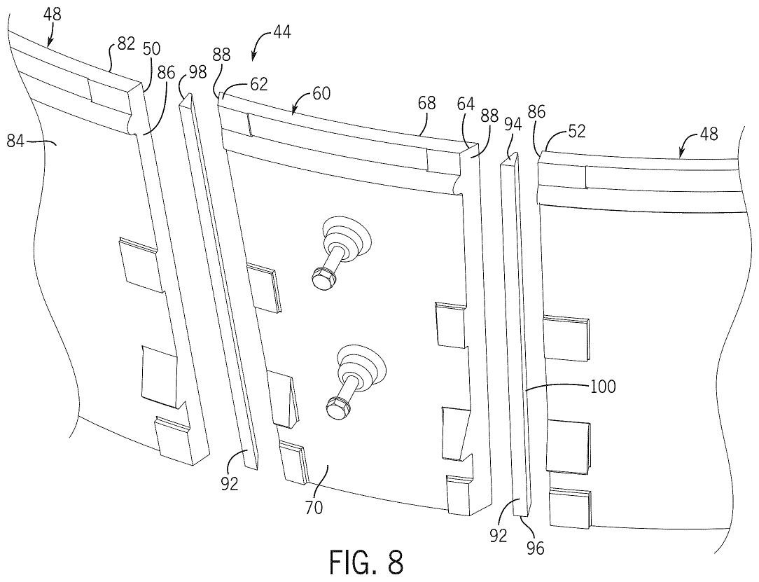

FIG. 8 illustrates an exploded and magnified view of the components used to complete the outer crushing shell 44 of the present disclosure. As described previously, a pair of concaves 48 are spaced from each other to define a receiving gap 58 between the side edges of the spaced concaves 48. Each of the concaves 48 includes an outwardly facing wear surface 82 and an inwardly facing back surface 84. The wear surface 82 is designed to face the crushing gap and to contact the material being crushed. The back surface 84 is designed to contact and be adhered to the inner wall of the frame of the upper top shell. The thickness of the concave 48 is thus defined as the thickness of the material between the wear surface 82 and the back surface 84.

As shown in FIG. 8, a straight side wall 86 connects the wear surface 82 to the back surface 84 at each of the spaced sides 50, 52 of the concave 48. In the embodiment shown in FIG. 8, the side wall 86 is a straight side wall that generally extends along the radius of the upper top shell. The straight side wall 86 is the same on both the first and second sides 50, 52 of each of the concaves 48. Thus, at the intersection between any of the two concaves other than at the location of the wedge concave 60, the straight, flat side walls 86 of adjacent concaves 48 contact each other and are in contact with each other along the entire height of the concave 48. Each of the plurality of concaves 48, other than the wedge concave 60, has an identical configuration such that the first and second sides 50, 52 of each of the concaves 48 can contact and engage each other to disperse the hoop stresses around the entire row of concaves 48 that form the outer crushing shell 44 shown in FIG. 4.

Referring back to FIG. 8, the wedge concave 60 also includes the wear surface 68 and the back surface 70 that are spaced from each other to define the thickness of the wedge concave 60. The wear surface 68 and the back surface 70 are joined by an angled side wall 88 at each of the first side 62 and the second side 64 of the wedge concave 60. As can be understood in FIG. 8, the length of the wear surface 68 between the first side 62 and the second side 64 is greater than the width of the back surface 70 between the same first and second sides 62, 64. Thus, each of the angled side walls 88 converge toward each other in a radially outward direction as referenced from the open interior of the upper top shell. Unlike the straight side walls 86 formed on the concaves 48, the angled side walls 88 formed on the wedge concave create an access gap 90 between the wedge concave 60 and the adjacent concaves 48, as best shown in FIG. 7. The access gap 90 increases in size from the wear surface 68 to the back surface 70 as illustrated. The access gap 90 increases in dimension as the access gap 90 extends radially outward. Thus, if a radial inward force is applied to the back surface 70, the wedge concave 60 is able to move toward the radial interior of the upper top shell.

As shown in FIGS. 7 and 8, the outer crushing shell of the present disclosure further includes a pair of wedges 92 that are each designed to be received within one of the access gaps 90. Each of the wedges 92 extends from an upper end 94 to a lower end 96. The overall height of each of the wedges 92 is slightly less than the height of the concaves 48 and the wedge concave 60. However, the height of each of the wedges 92 could vary from the height shown and could be up to the same overall height as the concaves 48 and the wedge concave 60. It is desired that the wedges 92 would not extend past either the top or bottom end of the concaves 48 or the wedge concave 60.

In exemplary embodiment, each of the wedges 92 includes a straight side wall 98 and an angled side wall 100 that each extend over the entire length of the wedge 92. As shown in the top view of FIG. 7, the straight side wall 98 of the wedge 92 contacts and interacts with the straight side wall 86 of the concave 48 while the angled side wall 100 of the wedge 92 has the same general angle as the angled side wall 88 of the wedge concave 60. The configuration of the straight side wall 98 and the angled side wall 100 of each of the wedges 92 create a significant amount of surface contact between the wedge 92 and both of the concave 48 and wedge concave 60. The wedges 92 are each the same component and the orientation of the wedge 92 is reversed such that the wedge 92 can be used on both sides of the wedge concave 60 as shown.

As described previously, the outer crushing shell 44 is designed to be mounted to the inner wall 42 of the frame 36 of the upper top shell 28, as can be best seen in FIGS. 2 and 3. During the installation process of the outer crushing shell 44, the plurality of concaves is initially installed in at least one row along the inner wall 42 of the frame 36. During this installation process, a receiving gap 58 is formed between two of the concaves 48 as can be seen in FIG. 5. The receiving gap 58 shown in FIG. 5 is a gap left between two of the concaves 48 in the hoop direction of the upper top shell. Each of the concaves 48 is generally supported on the inner wall 42 and an epoxy material is used to fill the open space 102 that exists between portions of the back surface 70 and the inner wall 42, as shown in FIG. 9. The epoxy received within the open space 102 helps to hold the individual concaves in place.

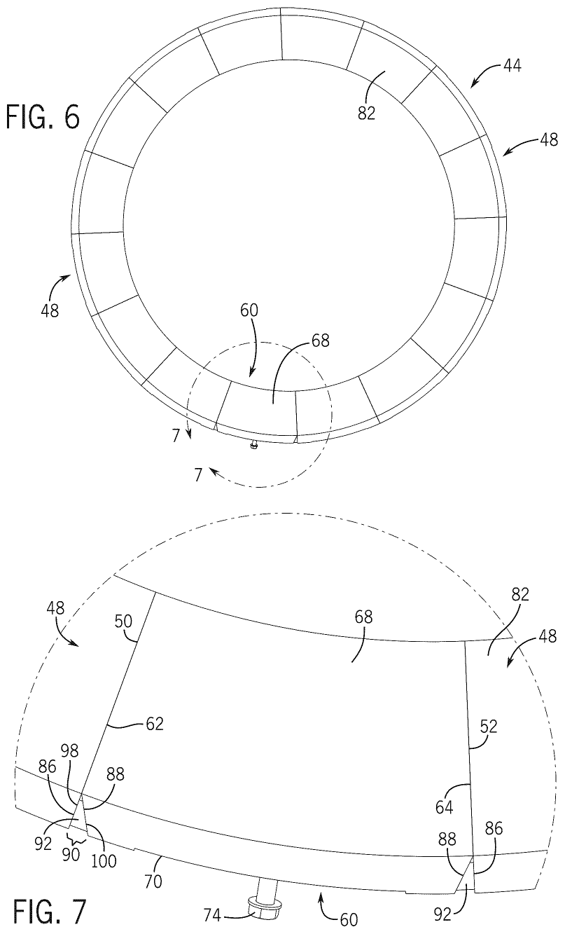

Once the concaves 48 have been installed and the receiving gap 58 is created, the wedge concave 60 is placed as shown in FIGS. 4 and 5. As discussed previously, the wedge concave 60 includes a pair of receiving bosses 72 that each include an internal threaded opening. As shown in FIG. 9, the pair of connecting bolts 74 extend through the frame 36 from an outside area of the frame 36. In this manner, the pair of connecting bolts 74 initially hold the wedge concave 60 in position within the receiving gap 58. As can be understood in the top views of FIGS. 6 and 7, when the wedge concave 60 is installed within the receiving gap, the first side 62 of the wedge concave 60 engages with the first side 50 of the left concave 48 while the second side 64 engages with the second side 52 of the right concave 48.

Once the wedge concave 60 is positioned, the pair of wedges 92 are each installed within the receiving gap 90 formed between the straight side wall 86 of one of the concaves 48 and the angled side wall 88 of the wedge concave 60. Each of the wedges 92 are inserted from above the assembled outer crushing shell. The size of each of the wedges 92 is selected such that during this installation process, the wedge 92 creates a holding force in the hoop direction. The shape of each of the wedges 92 is designed to prevent any radial outward movement of the wedge concave 60 during use of the gyratory crusher that utilizes the outer crushing shell 44.

Once each of the wedges 92 is installed, a layer of epoxy can be placed over the entire wear surface that is defined by the wear surface 68 of the wedge concave and the wear surface 82 of each of the concaves 48. The epoxy fills the gaps between adjacent concaves 48 and the wedge concave 60.

The removable and replaceable outer crushing shell 44 of the present disclosure is designed for replacement after a significant amount of wear has taken place during use of the gyratory crusher. The removal and replacement of the outer crushing shell 44, including the plurality of individual concaves 48 will now be described.

As shown in FIG. 7, the converging angled side walls 88 of the wedge concave 60 allow for the removal of the wedge concave 60 in a direction toward the interior of the frame of the upper top shell. Each of the wedges 92 is positioned and configured to prevent the outward movement of the wedge concave 60 but do not inhibit the removal of the wedge concave 60 in the radially inward direction.

Initially, each of the pair of connecting bolts 74 are removed to release the inner connection between the wedge concave 60 and the frame 36. Once the connecting bolts 74 have been removed, the wedge concave 60 can be pushed radially inward. Referring back to FIG. 9, a removal tool can be inserted through the frame 36 to aid in removing the wedge concave 60. In the exemplary embodiment shown, the removal tool is a release cylinders 104 can be mounted to the outer surface of the frame 36. The release cylinder 104 is a hydraulically operated cylinder that includes a cylinder rod that can be extended from a cylinder body to exert an outwardly directed force against the back surface 70 of the wedge concave 60. In the embodiment shown in FIG. 9, the release cylinder 104 is mounted in alignment with a cylinder bore 106. The cylinder bore 106 is generally located near the top end 108 of the wedge concave 60. The force exerted by the release cylinder 104 urges the top end 108 inward and away from the frame 36. The pushing force created by the release cylinder 104 removes the wedge concave 60 and releases all of the hoop stresses in the tier of the row of aligned concaves 48.

After the hoop stresses have been removed, each of the individual concaves 48 can be removed without the need for any heat cutting equipment. Although a release cylinder 104 is shown as the exemplary embodiment of a removal tool, it should be understood that different types of removal tools could be utilized to exert an inwardly directed release force on the back surface 70 of the wedge concave 60 to release the wedge concave from the frame 36.

In the embodiment illustrated, the upper top shell 28 shown in FIGS. 2 and 3 includes a single row of concaves 48. However, it should be understood that in other gyratory crusher designs, several rows of concaves 48 could be utilized, where each row of concaves 48 would include one of the wedge concaves 60. In such an embodiment, the removal of the rows of concaves would start with the uppermost row of concaves in the crusher.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A removable and replaceable crushing shell for use in a top shell of a gyratory or cone crusher, the top shell having a frame including a top end and a bottom end joined by an inner wall, the crushing shell comprising:
a plurality of concaves configured to be arranged in at least one row and supported along the inner wall of the top shell, each of the concaves including a wear surface and a back surface joined to each other by straight side walls located at first and second sides of the concave;
at least one wedge concave configured to be located between two adjacent concaves in the at least one row, the wedge concave including a wear surface and a back surface spaced by a thickness of the wedge concave, wherein the wear surface has a width greater than the width of the back surface and the wear surface is joined to the back surface by a pair of angled side walls at first and second sides of the wedge concave; and
a pair of wedges, wherein a first wedge is configured to be positioned between the straight side wall of a first concave and one of the angled side walls of the wedge concave and a second wedge is configured to be positioned between the straight side wall of a second concave and the other angled side wall of the wedge concave.

2. The crushing shell of claim 1 wherein the width of the wear surface and the width of the back surface of each of the plurality of concaves is generally the same such that the straight side walls of each of the plurality of concaves extend in a radially outward direction of the top shell.

3. The crushing shell of claim 1 wherein the angled side walls of the wedge concave converge in a radially outward direction of the top shell.

4. The crushing shell of claim 1 further comprising at least one connector configured to extend through a connector opening in the frame of the top shell from an outside of the frame and to be received in the back surface of the wedge concave to hold the wedge concave on the frame.

5. The crushing shell of claim 1 wherein each of the wedges includes a body having a straight side wall and an angled side wall, wherein the straight side wall is configured to contact the straight side wall of the first and second concaves and the angled side wall is configured to contact the angled side walls of the wedge concave.

6. A top shell for a gyratory or cone crusher, the top shell comprising:
a frame including a top end and a bottom end joined by an inner wall that defines a crushing chamber;
a plurality of concaves arranged in at least one row and supported along the inner wall of the top shell, each of the concaves including a wear surface facing the crushing chamber and a back surface in contact with the inner wall, wherein the wear surface and the back surface are joined to each other by straight side walls located at first and second sides of the concave;
at least one wedge concave positioned between two adjacent concaves, the wedge concave including a wear surface facing the crushing chamber and a back surface in contact with the inner wall, wherein the wear surface has a width greater than the width of the back surface and the wear surface is joined to the back surface by a pair of angled side walls at first and second sides of the wedge concave; and
at least a pair of wedges, wherein a first wedge is configured to be positioned between the straight side wall of a first concave and one of the angled side walls of the wedge concave and a second wedge is configured to be positioned between the straight side wall of a second concave and the other angled side wall of the wedge concave.

7. The top shell of claim 6 wherein the width of the wear surface and the width of the back surface of each of the plurality of concave is generally the same such that the straight side walls of each of the plurality of concaves extend in a radially outward direction of the top shell.

8. The top shell of claim 6 wherein the angled side walls of the wedge concave converge in a radially outward direction of the top shell.

9. The top shell of claim 6 further comprising at least one connector that extends through a connector opening in the frame of the top shell from an outside of the frame and is received in the back surface of the wedge concave to hold the wedge concave on the frame.

10. The top shell of claim 6 wherein each of the wedges includes a body having a straight side wall and an angled side wall, wherein the straight side wall is configured to contact the straight side wall of the concaves and the angled side wall is configured to contact the angled side walls of the wedge concave.

11. The top shell of claim 6 wherein an access gap located between the straight side wall of the concave and the angled side wall of the wedge concave, wherein each of the pair of wedges is received within one of the access gaps.

12. The top shell of claim 9 the at least one bolt is accessible from outside of the frame to selectively secure and release the wedge concave.

13. The top shell of claim 9 further comprising a bore formed in the frame of the top shell that is aligned with the wedge concave, wherein the bore is sized to receive a removal tool.

14. The top shell of claim 13 wherein the removal tool is a hydraulic cylinder.

15. A gyratory or cone crusher including the top shell of claim 6.

16. A method of installing a crushing shell on an inner wall of a frame of a top shell of a gyratory or cone crusher, the method comprising the steps of:
arranging a plurality of concaves in at least one row along the inner wall of the top shell with a back surface in contact with the inner wall and a wear surface facing a crushing chamber, wherein straight side walls of adjacent concaves contact each other;
creating a receiving gap between two of the concaves in a hoop direction of the top shell;
inserting a wedge concave within the receiving gap such that a portion of an angled side wall on each of first and second sides of the wedge concave contacts the straight side wall of the two concaves spaced by the receiving gap; and
inserting a wedge between the wedge concave and each of the two concaves spaced by the receiving gap to create a holding force between the plurality of concaves in the hoop direction.

17. The method of claim 16 further comprising the step of connecting the wedge concave to the frame by inserting at least one connector through a connector opening in the frame of the top shell from an outside of the frame, wherein the connector is received in the back surface of the wedge concave to hold the wedge concave on the frame.

18. The method of claim 16 wherein each of the plurality of concaves includes a pair of straight side wall and the wedge concave includes a pair of angled end wall, wherein an access gap is located between the straight side wall of the concave and the angled side wall of the wedge concave and each of the wedges is received within one of the access gaps.

19. The method of claim 16 further comprising the steps of:
removing the at least one connector; and
positioning a release cylinder along the frame; and
operating the release cylinder to exert a release force on the back surface of the wedge concave.

20. The method of claim 18 wherein wedges are inserted into the access gaps from above or below the row of concaves.
